(19) United States
(12) Patent Application Publication
(10) Pub. No.: US 2021/0147638 A1
(43) Pub. Date: May 20, 2021

(54) Composite Material

(71) Applicant: Peratech Holdco Ltd, Brompton On Swale, Richmond (GB)

(72) Inventor: Sarah Jessica Dempsey, Durham (GB)

(21) Appl. No.: 16/606,110

(22) PCT Filed: Apr. 18, 2018
(86) PCT No.: PCT/GB2018/000069

§ 371 Date: Oct. 17, 2019

(30) Foreign Application Priority Data
Apr. 21, 2017 (GB) 1706363.7

(51) Int. Cl. C08J 3/21; B01F 9/00; B01F 3/12; B01F 3/22; C08J 3/12; H01B 1/20; C08K 3/22; C08K 7/18

(52) U.S. Cl. CPC C08J 3/212; C08K 2201/011; B01F 3/1214; B01F 3/1221; B01F 3/2284; C08J 3/12; H01B 1/20; C08K 3/22; C08K 7/18; B01F 2215/0459; B01F 2215/0049; C08J 2300/24; C08J 2483/04; C08K 2003/2231; C08K 2201/001; C08K 2201/005; B01F 9/0003

(57) ABSTRACT

A composite material (101) is produced by obtaining a plurality of agglomerates (102), introducing the plurality of agglomerates into a liquid carrier including a component capable of solidifying to produce a solidified polymeric material and mixing the plurality of the agglomerates into the liquid carrier (103) to produce a composite material. Each agglomerate is pre-formed by obtaining a plurality of electrically conductive or semi-conductive particles, mixing the plurality of electrically conductive or semi-conductive particles (201) in a granulation vessel. The mixing step includes operating the granulation vessel (202) at a Froude number of between 220 and 1100 and adhering the plurality of electrically conductive or semi-conductive particles by adding a granulation binder to a plurality of agglomerates.

### CROSS REFERENCE TO RELATED APPLICATIONS

This application claims priority from United Kingdom Patent Application No. GB 17 06 363.7, filed on 21 Apr. 2017, the entire disclosure of which is incorporated herein by reference in its entirety.

### BACKGROUND OF THE INVENTION

The present invention relates to a method of producing a composite material and method of producing a plurality of agglomerates, and an electrically responsive composite material and agglomerates for use in an electrically responsive composite material.

User input devices are known that are substantially flat and are responsive to movement of a stylus or finger in an xy plane, and in some cases, also sensitive to pressure applied in the z dimension. When incorporated into touch screens, it has previously proved difficult to produce transparent touch screens which operate in both the xy plane and the z dimension, this problem being previously identified in the applicant's patent EP 2 689 431.

EP 2 689 431 provides a pressure sensitive composite material which comprises a plurality of agglomerates dispersed within a carrier layer. In manufacture, these agglomerates are spontaneously formed by a process of mixing conductive or semi-conductive particles in combination with a polymeric material to produce the composite material in question. During mixing, the conductive or semi-conductive particles combine with other conductive or semi-conductive particles to form the agglomerates within the carrier layer. Thus, the formed agglomerates are dependent on the mixing process of the composite material and require a limitation of hyper-dispersant levels so that the agglomerates can form. The resulting agglomerates are often irregular with varying mechanical and electrical properties and the composite material often includes small agglomerates which provide limited conduction through the carrier layer and optical haze through an otherwise transparent or translucent material.

### BRIEF SUMMARY OF THE INVENTION

According to an aspect of the present invention, there is provided a method of producing a plurality of agglomerates for inclusion in an electrically responsive composite material, comprising the steps of: obtaining a plurality of electrically conductive or semi-conductive particles; mixing said plurality of electrically conductive or semi-conductive particles in a centrifugal mixer, said mixing step comprising operating said centrifugal mixer at a Froude number of between 220 and 1100; and adhering said plurality of electrically conductive or semi-conductive particles by adding a granulation binder and mixing said granulation binder with said plurality of electrically conductive or semi-conductive particles to form a plurality of agglomerates; wherein each said step of obtaining, mixing and adhering said electrically conductive or semi-conductive particles pre-forms said plurality of agglomerates prior to introduction of said plurality of agglomerates into said electrically responsive composite material.

Embodiments of the invention will be described, by way of example only, with reference to the accompanying drawings. The detailed embodiments show the best mode known to the inventor and provide support for the invention as claimed. However, they are only exemplary and should not be used to interpret or limit the scope of the claims. Their purpose is to provide a teaching to those skilled in the art.

Components and processes distinguished by ordinal phrases such as “first” and “second” do not necessarily define an order or ranking of any sort.

### BRIEF DESCRIPTION OF THE SEVERAL VIEWS OF THE DRAWINGS

FIG. 1 shows an electrically responsive composite material;

FIG. 2 shows a schematic method of producing a plurality of agglomerates;

FIG. 3 shows a schematic representation of a granulation vessel in the form of a dual axis centrifugal mixer;

FIG. 4 shows a graph of Froude number against the rotational speed for a granulation vessel in accordance with the present invention;

FIG. 5 shows a graph of rotational speed against the granulation time for a granulation vessel in accordance with the present invention;

FIG. 6 shows agglomerates have a plurality of indentations on their surface;

FIG. 7 shows a method of producing a plurality of agglomerates;

FIG. 8 shows a composite material having a plurality of pre-formed agglomerates;

FIGS. 9A and 9B show a diagrammatic illustration of conduction paths through a composite material; and

FIG. 10 shows a force resistance response curve for composite materials.

### DETAILED DESCRIPTION OF THE INVENTION

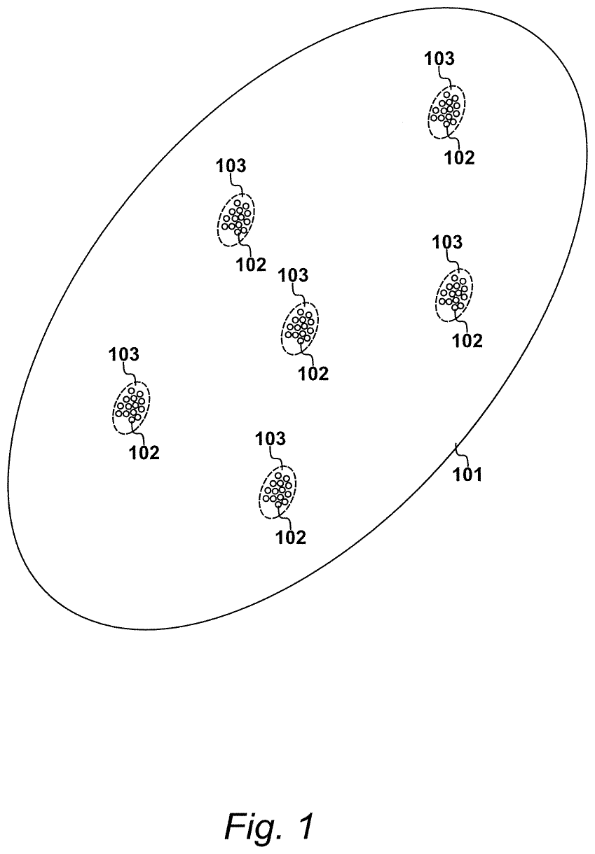

FIG. 1

An electrically responsive composite material 101 is illustrated in FIG. 1. Electrically responsive composite material 101 is suitable for applying to a suitable substrate and can thus be incorporated into an electronic device such as a touch screen. Composite material 101 comprises a plurality of agglomerates 102 which are dispersed within a carrier layer 103. Carrier layer 103 comprises a polymer binder which can be cross-linkable, solvent-based, thermally or uv-curable. The polymer binder may also be opaque, translucent or substantially transparent and remains such after cross-linking, solvent evaporation or curing.

Each of the agglomerates 102 comprise a plurality of electrically conductive or semi-conductive particles 103 which are adhered together to form the agglomerates 102. In manufacture, the agglomerates are pre-formed and then dispersed within the carrier layer in the manner of FIG. 1. Pre-formed is used throughout this specification to indicate that the agglomerates are produced by combining a plurality of electrically conductive or semi-conductive particles separately and before combining the agglomerates with the carrier layer. Additionally, agglomerate is used throughout the specification to refer to a granular particle which has been formed from a plurality of electrically conductive or semi-conductive particles though a granulation method and which is able to provide conduction through the agglomerate itself. Thus, each individual agglomerate can then be combined with appropriate carrier binders to produce conductive composite materials.

The size and dispersion of the agglomerates (shown greatly enlarged in FIG. 1) is such as to render them invisible to an unaided eye. Thus, the size of the agglomerates is such that a thin coating of the electrically responsive composite material appears optically substantially the same as without the addition of the filler particles. Furthermore, as the agglomerates are dispersed within the carrier layer, the composite material as a whole may take the optical appearance of the polymer binder.

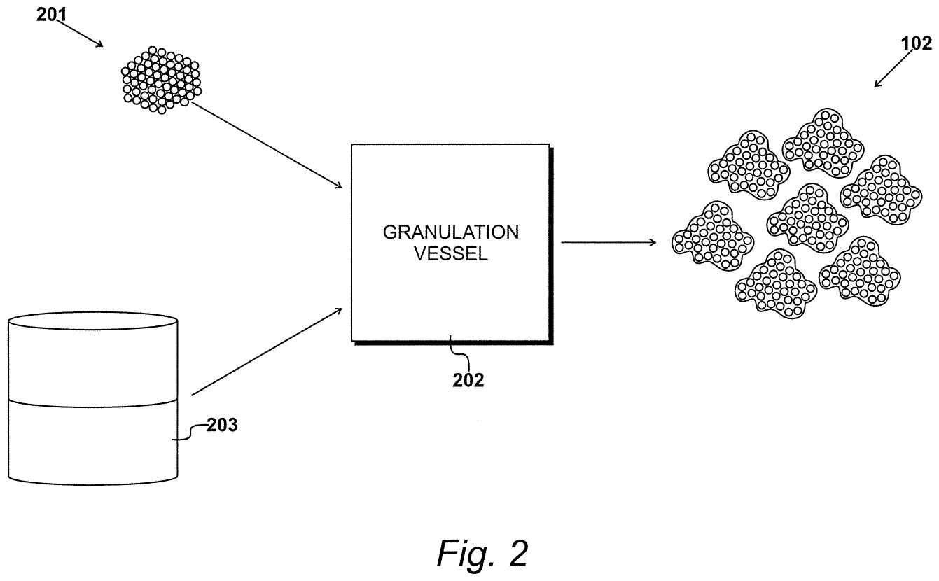

FIG. 2 FIG. 2 shows a schematic of a method of producing a plurality of agglomerates 102 which are suitable for inclusion in an electrically responsive composite material, such as electrically composite material 101 as previously described in FIG. 1. It is noted that the schematic is diagrammatical in nature and therefore not to scale.

In order to produce the plurality of agglomerates 102, a plurality of electrically conductive or semi-conductive particles 201 are obtained and are placed into a granulation vessel 202. A granulation binder 203 is also added into the granulation vessel 202. The granulation vessel 202 is configured to perform a mixing process so that the plurality of electrically conductive or semi-conductive particles 201 adhere to each other during the mixing process. In the embodiment, particles 201 adhere together due to the presence of binder 203. In this way, the plurality of agglomerates 102 comprise a plurality of electrically conductive or semi-conductive particles 201 which have been adhered together by the mixing process performed by the granulation vessel 202.

In the embodiment, the ratio of the plurality of electrically conductive or semi-conductive particles 201 to granulation binder 203 is 10:1 weight/weight. Thus, it is appreciated that the amount of granulation binder used to adhere the particles together is relatively small compared to the amount of particles which form each agglomerate. It is further appreciated that, in alternative embodiments, alternative ratios which allow the electrically conductive and/or semi-conductive particles to adhere to each other are used.

In an embodiment, the conductive particles comprise antimony doped tin oxide particles. These are illustrated as spherical particles; however, it is appreciated that, in alternative embodiments, the particles are acicular (or needle shaped). The electrically conductive or semi-conductive particles typically have a largest dimension of between ten (10) and one hundred (100) nanometres (nm).

In an embodiment, granulation binder 203 comprises a silicone liquid binder, and in particular, comprises a two-part translucent high consistency rubber of which the main constituent is polydimethylsiloxane (PDMS). In an alternative embodiment, the granulation binder comprises a carbon-based (organic) binder such as an alcohol/petrol resistant (APR) varnish. In a further alternative embodiment, the granulation binder comprises a water-based binder, for example a transparent screen-printable ink containing no organic solvent. In still further embodiments, other suitable granulation binders may be used.

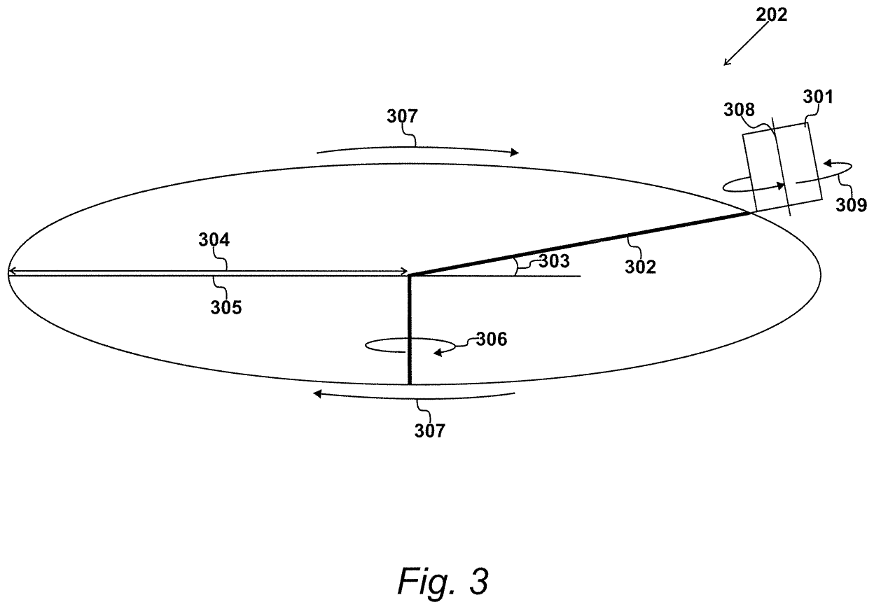

Granulation vessel 202 is configured to mix the particles and granulation binder at relatively high energies so as to produce agglomerates which do not break up easily. In an embodiment, the granulation vessel is a centrifugal mixer. In a particular embodiment, the centrifugal mixer has a dual axis of rotation, such as a SpeedMixer™ DAC 150.1 FVZ dual asymmetric centrifugal laboratory mixer as will be described in further detail with respect to FIG. 3.

FIG. 3

A schematic representation of a granulation vessel in the form of a dual axis centrifugal mixer which is suitable for performing a granulation process in accordance with the present invention is shown with respect to FIG. 3. It is appreciated that the granulation vessel of FIG. 2 can be any other suitable vessel which is able to produce suitable agglomerates of the type described herein, with FIG. 3 providing a suitable example which is able to achieve the agglomerates herein described.

A sample container 301 is provided into which the plurality of electrically conductive or semi-conductive particles 201 can be added along with the corresponding granulation binder 203. Sample container 301 is positioned at one end of a rotational arm 302 which is inclined at an angle 303 to the horizontal 304 about the cylindrical vessel having a radius 305. In an embodiment, angle 303 is set at forty degrees (40°) to the horizontal 304, with the radius being eighty millimetres (80 mm).

In use, rotational arm 302 is rotated about a central rotation axis 306, so that the sample container 301, due to its position at the end of rotational arm 302, moves in a circular manner in the direction of arrows 307. The dual axis centrifugal mixer 202 is further configured to rotate sample container 301 about a secondary rotation axis 308, in an opposed direction to that of the central rotation 306. This is indicated by the arrow 309.

The use of a dual asymmetric centrifuge of this type is advantageous as it promotes rapid homogenisation of the sample in the container and reduces air bubbles in the sample. This is due to the high acceleration and opposing centripetal forces imposed by the opposing axes. Traditionally, this type of mixer is not used for granulation processes, but for mixing two separate liquids together. The applicant has found, however, that a dual axis mixer of this type produces suitable agglomerates for use in an electrically responsive composite material.

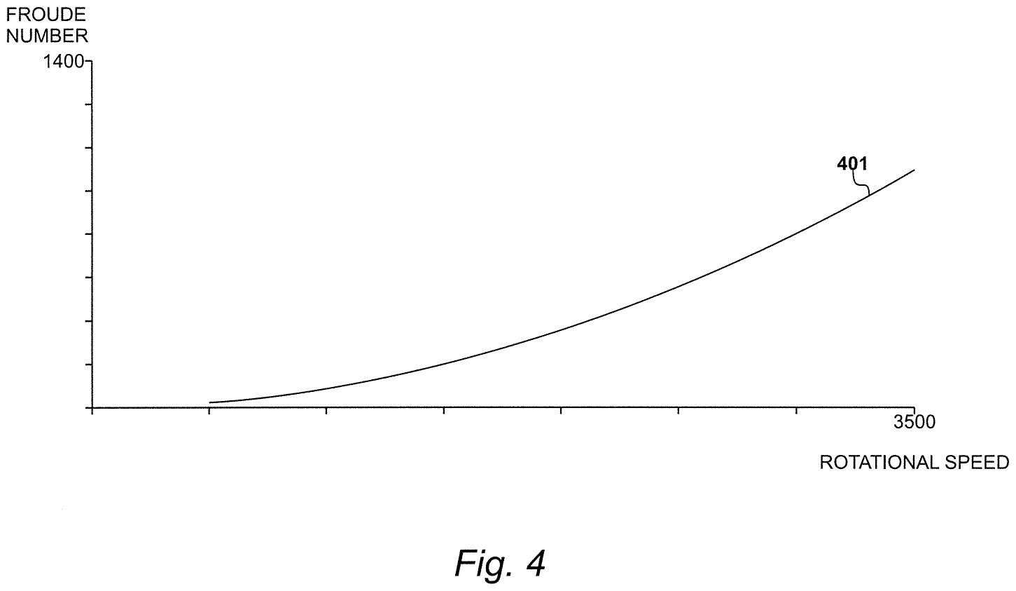

The nature of this particular granulation vessel is that parameters such as the radius of rotation and speed of rotation can be varied to provide suitable results. In the embodiment, while the radius of rotation is maintained as a function of a particular mixer, the speed of rotation is relatively high which produces a high Froude number as will described in detail with respect to FIG. 4.

FIG. 4

The dual axis centrifugal mixer as described in respect of FIG. 3 is configured to operate at a high energy having a Froude number of between 220 and 1100. The Froude number of a granulator is a measure of the centripetal acceleration acting on the sample in the sample container as a ratio of the gravitational acceleration. It is therefore defined by the square of the angular velocity multiplied by the characteristic radius of the granulation vessel and divided by the gravitational acceleration. Control of the Froude number of the granulation vessel in use can be used to compare the energy of granulation imparted onto the particles.

FIG. 4 illustrates a graph of Froude number against the rotational speed about the central axis 306 in revolutions per minute (rpm). Line 401 shows the variation in Froude number with increased rotational speed. In the embodiment, the centrifugal mixer of FIG. 3 operates at a rotational speed of between 1000 and 3500 rpm which produces a corresponding Froude number of between 220 and 1100. In particular, at a speed of 3500 a Froude number of 1096 has been measured. In a further embodiment, a Froude number of between 229 and 1095 corresponds to a rotational speed of between 1600 and 3500 rpm.

In conventional granulation vessels, it is typical for Froude numbers to range between 0.2 to around 100, and therefore the present invention imparts much higher energies into the sample (i.e. the granulation binder and electrically conductive or semi-conductive particles) than would normally be expected in a granulation process.

While a dual axis centrifugal mixer is described here, it is appreciated that alternative granulation vessels may be used provided that they are able to input a suitably high Froude number to provide suitable agglomerates by means of a substantially similar granulation process.

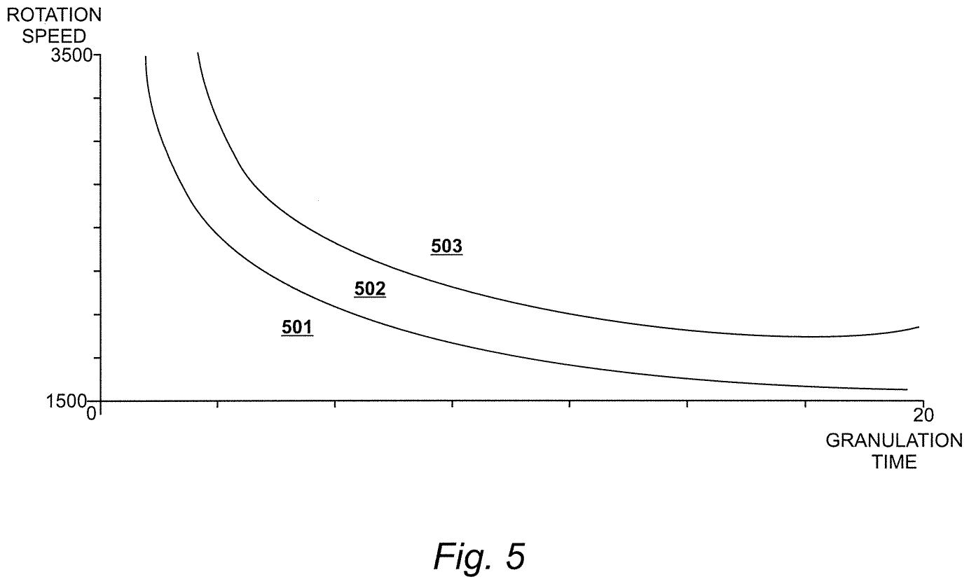

FIG. 5

To further illustrate the parameters used in the method of production of pre-formed agglomerates suitable for use in an electrically responsive conductive material, a graph of rotational speed (revolutions per minute−rpm) against the granulation time (minutes) is shown in FIG. 5. The graph described in respect of FIG. 5 is illustrative of the process by which the agglomerates are formed through granulation. The granulation process involves a nucleation phase which results in relatively small agglomerates. This phase is then followed by a rapid growth phase in which an increased number of conductive particles join or stick to the forming agglomerate. Thus, the graph of FIG. 5 illustrates how the timing of these phases can be controlled to result in agglomerates of different properties.

The graph illustrates three regions, 501, 502 and 503 indicating the relationship between the two parameters and the corresponding size of agglomerates produced. In region 501, agglomerates were produced of sizes having a greatest dimension of less than ten micrometres (10 μm). Thus, in this region, the agglomerates produced are relatively small. In region 502, the agglomerates larger, surface-smooth agglomerates are produced which typically have a largest dimension of between twenty and forty micrometres (20-40 μm). In region 503, the agglomerates are larger and may be more than forty micrometres (40 μm) across their largest dimension. Agglomerates in region 503 have been noted to include a plurality of indentations on their surface which provides an appearance similar to a golf-ball.

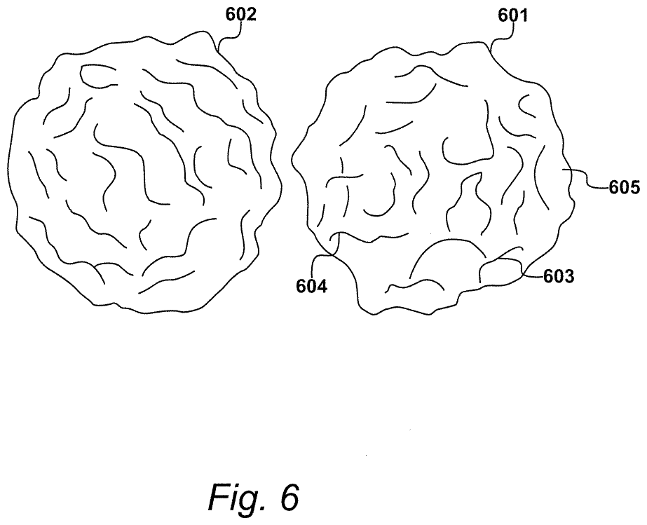

Thus, in an embodiment, the agglomerates have a largest dimension of between four and twenty micrometres (4-20 μm) and preferably between four and ten micrometres (4-10 μm) and typically have a smooth surface and relatively consistent overall size. However, in an alternative embodiment, the agglomerates produced are larger and have indentations on their surface, as will be described in further detail in FIG. 6.

FIG. 6

Example agglomerates in accordance with the present invention are shown in FIG. 6. Agglomerates 601 and 602 have been produced by the method described previously in respect of FIG. 2.

In this embodiment, the agglomerates have been produced in line with the parameters of region 3 of the graph of FIG. 5. Thus, agglomerates 601 and 602 include a plurality of indentations, such as indentations 603 and 604 on surface 605 of agglomerate 601. Thus, these agglomerates have a relatively large surface area compared to agglomerates having a smooth surface. In this embodiment, the largest dimension of the agglomerates (in this case the diameter) is typically between twenty and forty micrometres (20-40 μm); however, agglomerates of over forty micrometres (40 μm) can be produced in this manner.

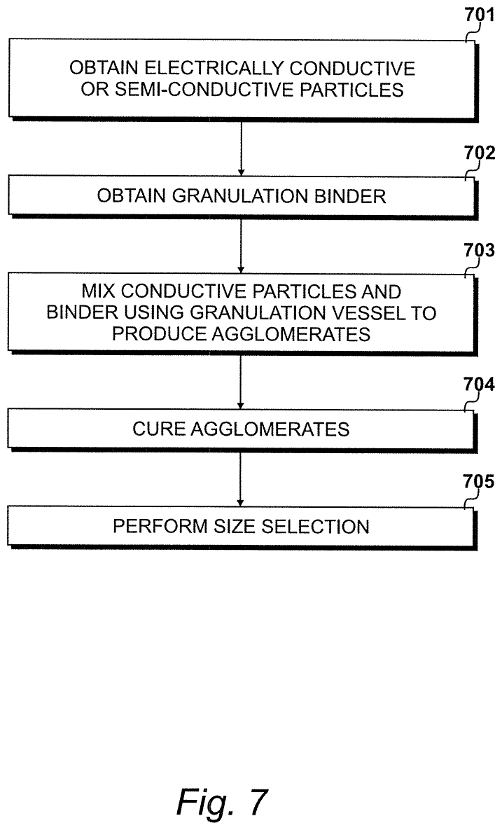

FIG. 7

A method of producing a plurality of agglomerates of the types previously described herein is shown in diagrammatic form in FIG. 7.

At step 701, electrically conductive or semi-conductive particles 201 are obtained. In an embodiment, the particles 201 comprise antimony doped tin oxide spherical particles. In an alternative embodiment, the antimony doped tin oxide particles are acicular or needle-shaped. Each particle typically has a largest dimension of between ten and one hundred nanometres (10-100 nm).

At step 702 a granulation binder 203 is obtained. The granulation binder is in the form of a liquid and is typically a silicone liquid binder such as one which comprises a two-part translucent high consistency rubber of which the main constituent is polydimethylsiloxane (PDMS). In an alternative embodiment, granulation binder 203 comprises a carbon-based (organic) binder such as an alcohol/petrol resistant (APR) varnish. In a further alternative embodiment, the granulation binder comprises a water-based binder, for example a transparent screen-printable ink containing no organic solvent.

The particles and granulation binder are introduced into a granulation vessel in the manner of FIG. 2 and undergo a mixing process which adheres the particles together to produce agglomerates at step 703. The process of mixing and adhering the particles can be varied as described above in order to obtain agglomerates having particular properties, such as varied sizes, shapes, or porosity, which is affected by the granulation time. The agglomerates are then removed from the granulation vessel and undergo a curing process at step 704. In an embodiment, this involves placing the agglomerates into a suitable oven and applying a heating process to the agglomerates.

At step 705, the agglomerates undergo a further size selection process which ensures that each said agglomerate is within a predetermined size range. For example, in an embodiment, the agglomerates are sieved at twenty micrometres (20 μm) so maintain the agglomerates as being smaller than twenty micrometres (20 μm). This assists in ensuring that the agglomerates are of a suitable size for any future applications, such as the inclusion into an electrically responsive composite material. It is appreciated that other size selection processes may be utilised that allow the agglomerates to be sorted in accordance with their future applications.

Once the plurality of agglomerates have been suitably formed as described, they are then able to be used in the production of a composite material, which in turn can form part of a touch screen or other electronic device.

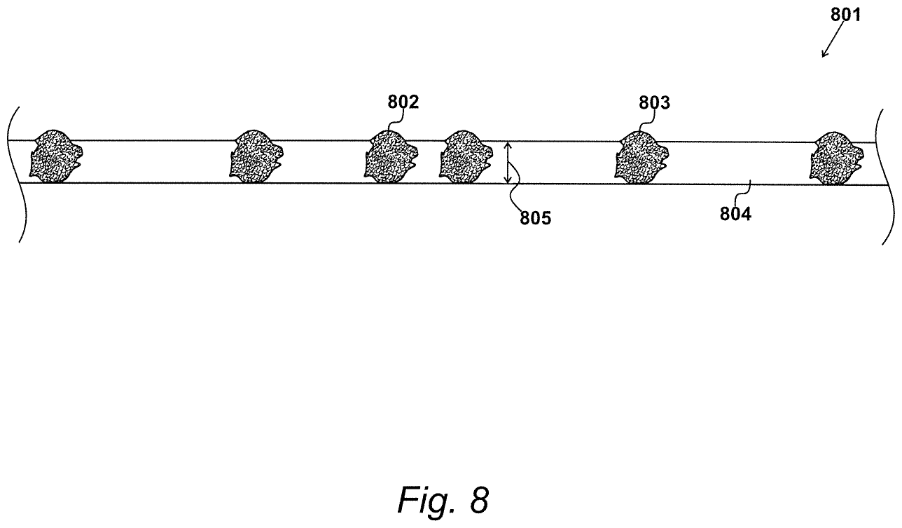

In order to produce a composite material, the plurality of agglomerates are introduced into a liquid carrier and mixed into the liquid carrier to produce the composite material which will now be described with respect to FIG. 8.

FIG. 8

A composite material 801 having a plurality of agglomerates, such as agglomerates 802 and 803, which have been pre-formed by the method herein described, is shown in FIG. 8.

The plurality of agglomerates (802, 803) have been introduced into a liquid carrier which has been solidified to produce a solidified polymeric material. In an embodiment, the carrier layer comprises any suitable liquid carrier which comprises a component capable of solidifying to produce a solidified polymeric material and in order to produce the composite material, the agglomerates are introduced into the liquid carrier and mixed to disperse the agglomerates within the liquid carrier before solidification takes place.

The resultant carrier layer 804 has a length and a width and a thickness 805 which is relatively small compared to the width. In the embodiment, the thickness 805 is between four and six micrometres (4-6 μm).

The plurality of agglomerates (802, 803) have a largest dimension of between four and twenty micrometres (4-20 μm), but in the embodiment, the largest dimension is typically between four and ten micrometres (4-10 μm). In particular, the thickness 805 of carrier layer 804 is smaller than the largest dimension of each agglomerate. For example, the agglomerates have a largest dimension of between eight and ten micrometres (8-10 μm) for a carrier layer thickness of six micrometres (6 μm). Thus, in this way, the agglomerates protrude slightly from the solidified carrier layer so that they are able to provide a conductive path.

In contrast to previous method of manufacture, because the agglomerates have been pre-formed prior to their inclusion into the liquid binder, the agglomerates are able to be provided with consistent properties, both mechanical and electrical. Thus, this reduces the number of particles which do not form usable agglomerates, for example, those which are too small to provide a conductive path through the carrier layer.

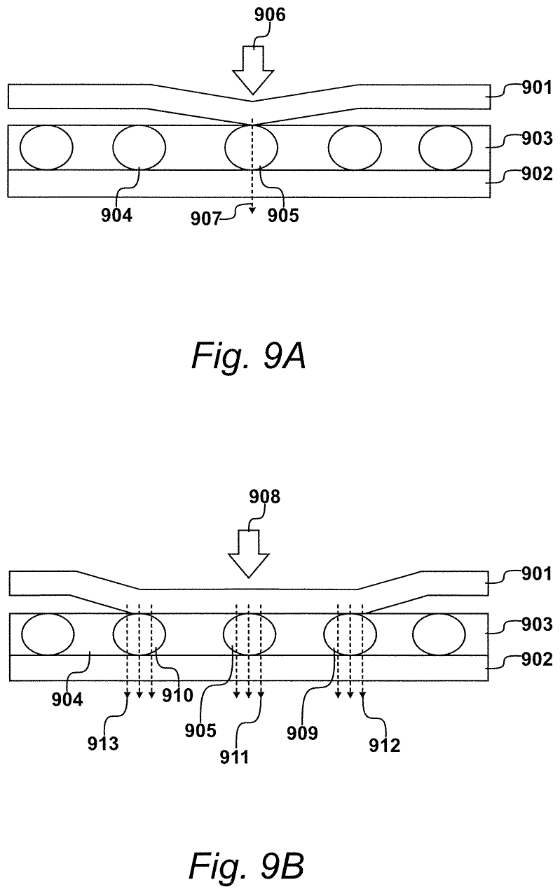

FIG. 9

A diagrammatic illustration of conduction paths through a composite material in accordance with the invention is shown in FIG. 9. In this example embodiment, the composite material has been incorporated into a touch screen having a deformable electrode of indium tin oxide (ITO) 901 and a rigid electrode of indium tin oxide (ITO) 902. A composite material 903 is sandwiched between the two electrodes 901 and 902, which comprises a solidified polymeric insulating carrier layer 904 and a plurality of agglomerates, such as agglomerate 905.

When a low force is applied to deformable electrode 901, indicated by arrow 906, agglomerate 905 is brought into contact with electrode 901 which creates a limited conduction path indicated by arrow 907, as shown in FIG. 9A. In contrast, with respect to FIG. 9B, when a larger force, indicated by arrow 908, is applied to electrode 901, contact is made, not only with agglomerate 905, but also agglomerates 909 and 910. Conduction paths are illustrated by arrows 911, 912 and 913. Thus, with increased force, contact is made with an increased number of agglomerates, thus increasing the conduction path. Furthermore, the agglomerates themselves may exhibit a pressure sensitive electrical resistance, such that with a higher applied force, there is also a further increase in conduction for this reason.

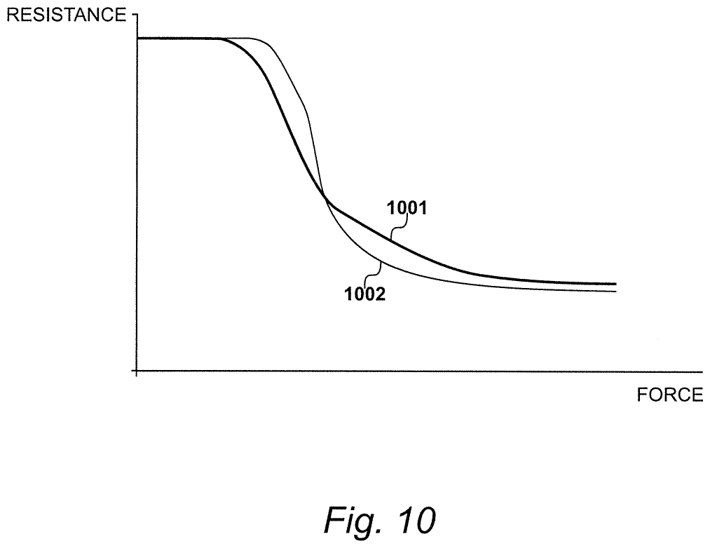

FIG. 10

A graph of force against resistance for samples corresponding to composite materials of the type previously manufactured in accordance with the applicant's patent EP 2 689 431, and composite materials in accordance with the present invention is shown in FIG. 10.

Line 1001 shows the force-resistance response of a sample in accordance with the present invention, where the agglomerates have been pre-formed. Line 1002 shows the force-resistance response of a sample in accordance with the previously known method which creates agglomerates spontaneously. In the sample used here, the agglomerates were pre-formed using a centrifugal mixer as described with respect to FIG. 3, at a rotational speed of 2000 rpm for four minutes.

It is noted that the present invention produces a less sensitive force-resistance response at low forces, meaning the composite material operates less like a switch than conventional methods. This can be useful in digital on/off applications. Visible light transmission is also improved as there is reduced haze from lack of non-conducting smaller agglomerates.

Thus, the present invention not only provides a suitable method for controlling the parameters of the agglomerates to suit a particular application, but also provides characteristics that are not provided by spontaneous agglomerate formation.

The invention claimed is:

1. A method of producing a composite material, comprising the steps of:
obtaining a plurality of agglomerates;
introducing said plurality of agglomerates into a liquid carrier comprising a component capable of solidifying to produce a solidified polymeric material; and
mixing said plurality of agglomerates into said liquid carrier to produce a composite material; wherein each said agglomerate is pre-formed by:
obtaining a plurality of electrically conductive or semi-conductive particles;
mixing said plurality of electrically conductive or semi-conductive particles in a granulation vessel, said mixing step comprising operating said granulation vessel at a Froude number of between 220 and 1100; and
adhering said plurality of electrically conductive or semi-conductive particles by adding a granulation binder to form said plurality of agglomerates.

2. A method of producing a composite material according to claim 1, wherein said granulation vessel comprises a centrifugal mixer.

3. A method of producing a composite material according to claim 2, wherein said centrifugal mixer has a dual axis of rotation.

4. A method of producing a composite material according to claim 2 or claim 3, wherein said centrifugal mixer is rotated at a speed of between 1000 and 3500 rpm.

5. A method of producing a composite material according to any of claims 1 to 4, wherein said granulation binder is added at a ratio of said plurality of electrically conductive or semi-conductive particles to binder of 10:1 weight/weight.

6. A method of producing a composite material according to any one of claims 1 to 5, wherein said granulation binder comprises a silicone liquid binder.

7. A method of producing a plurality of agglomerates for inclusion in an electrically responsive composite material, comprising the steps of:
obtaining a plurality of electrically conductive or semi-conductive particles;
mixing said plurality of electrically conductive or semi-conductive particles in a granulation vessel, said mixing step comprising operating said granulation vessel at a Froude number of between 220 and 1100; and
adhering said plurality of electrically conductive or semi-conductive particles by adding a granulation binder to form a plurality of agglomerates.

8. A method of producing a plurality of agglomerates according to claim 7, further comprising the step of: performing a size selection process to ensure each said agglomerate is within a predetermined size range.

9. A method of producing a plurality of agglomerates according to claim 8, wherein said size selection process comprises sieving.

10. A method of producing a plurality of agglomerates according to any one of claims 7 to 9, further comprising the step of curing each said agglomerate by a heating process.

11. An electrically responsive composite material, comprising:
a carrier layer comprising a solidified polymeric material having a length and a width and a thickness that is relatively small compared to said length and said width; and
a plurality of agglomerates dispersed within the carrier layer, wherein
each said agglomerate is pre-formed by obtaining a plurality of electrically conductive or semi-conductive particles; mixing said plurality of electrically conductive or semi-conductive particles in a granulation vessel at a Froude number of between 220 and 1100; and adhering said plurality of electrically conductive or semi-conductive particles by means of a granulation binder to form said plurality of agglomerates.

12. An electrically responsive composite material according to claim 11, wherein each said agglomerate comprises a surface having a plurality of indentations.

13. An electrically responsive composite material according to claim 11 or claim 12, wherein said plurality of electrically conductive or semi-conductive particles comprise antimony doped tin oxide spherical particles.

14. An electrically responsive composite material according to any of claims 11 to 13, wherein each said agglomerate has a largest dimension of between 4 and 20 micrometres.

15. An electrically responsive composite material according to claim 14, wherein each said agglomerate has a largest dimension of between 4 and 10 micrometres.

16. An electrically responsive composite material according to claim 14 or claim 15, wherein said carrier layer has a thickness which is smaller than the largest dimension of each said agglomerate.

17. An electrically responsive composite material according to any of claims 12 to 16, wherein each said electrically conductive or semi-conductive particle has a largest dimension of between 10 and 100 nanometres.

18. A plurality of agglomerates, each said agglomerate comprising a plurality of electrically conductive or semi-conductive particles missed by a granulation vessel at a Froude number of between 220 and 1100 and adhered by means of a granulation binder so as to pre-form said plurality of agglomerates for inclusion into a composite material.

19. A plurality of agglomerates according to claim 18, wherein each said agglomerate comprises a surface having a plurality of indentations.

20. A plurality of agglomerates according to claim 19, wherein each said agglomerate has a largest dimension of more than 40 micrometres.
